(19) United States
(12) Patent Application Publication
(10) Pub. No.: US 2014/0098830 A1
(43) Pub. Date: Apr. 10, 2014

(54) EXTREME ULTRAVIOLET LIGHT GENERATION SYSTEM

(71) Applicant: Gigaphoton Inc., Oyama (JP)

(72) Inventors: Takayuki YABU, Oyama (JP); Takashi SAITO, Oyama (JP); Hideyuki HAYASHI, Oyama (JP); Kazuhiro SUZUKI, Oyama (JP); Hiroaki NAKARAI, Oyama (JP)

(73) Assignee: GIGAPHOTON INC., Oyama (JP)

(21) Appl. No.: 14/047,753

(22) Filed: Oct. 7, 2013

(30) Foreign Application Priority Data
Oct. 10, 2012 (JP) 2012-225305

(51) Int. Cl. H01S 3/00

(52) U.S. Cl. CPC H01S 3/0085
USPC 372/30

(57) ABSTRACT

An extreme ultraviolet light generation system may include an optical device configured to cause an optical path of a pulse laser beam to approximately match one of a first optical path in which the pulse laser beam is focused at a plasma generation region and a second optical path in which the pulse laser beam passes outside the plasma generation region, and a control unit configured to output a control signal to the optical device so that the optical device sets the optical path of the pulse laser beam to the second optical path from when a predetermined time starts to when the number of pulses contained in a timing signal reaches a predetermined value and sets the optical path of the pulse laser beam to the first optical path from when the number of pulses reaches the predetermined value to when the predetermined time ends.

### CROSS-REFERENCE TO A RELATED APPLICATION

The present application claims priority from Japanese Patent Application No. 2012-225305 filed Oct. 10, 2012.

### BACKGROUND

1. Technical Field

The present disclosure relates to extreme ultraviolet light generation systems.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

An extreme ultraviolet light generation system according to an aspect of the present disclosure may include a laser device, a chamber, a target supply device, a focusing optical system, an optical device, and a control unit. The laser device may be configured to output a pulse laser beam. The chamber may be provided with at least one opening for introducing the pulse laser beam. The target supply device may be configured to supply a plurality of targets consecutively to a plasma generation region within the chamber. The focusing optical system may be configured to focus the pulse laser beam. The optical device may be configured to cause an optical path of the pulse laser beam to approximately match one of a first optical path in which the pulse laser beam is focused at the plasma generation region and a second optical path in which the pulse laser beam passes outside the plasma generation region. The control unit may be configured to output, to the laser device, a trigger signal obtained by applying a predetermined delay time to a timing signal indicating a timing at which the target is to be supplied by the target supply device so that the laser device outputs the pulse laser beam throughout a predetermined time, to count the number of pulses contained in the timing signal, and to output a control signal to the optical device so that the optical device sets the optical path of the pulse laser beam to the second optical path from when the predetermined time starts to when the number of pulses reaches a predetermined value and sets the optical path of the pulse laser beam to the first optical path from when the number of pulses reaches the predetermined value to when the predetermined time ends.

An extreme ultraviolet light generation system according to another aspect of the present disclosure may include a laser device, a chamber, a target supply device, a focusing optical system, and a control unit. The laser device may be configured to output a pulse laser beam. The chamber may be provided with at least one opening for introducing the pulse laser beam. The target supply device may be configured to supply a plurality of targets consecutively to a plasma generation region within the chamber. The focusing optical system may be configured to focus the pulse laser beam at the plasma generation region. The control unit may be configured to output, to the laser device, a trigger signal obtained by applying one of a first delay time and a second delay time to a timing signal indicating a timing at which the target is to be supplied by the target supply device so that the laser device outputs the pulse laser beam throughout a predetermined time, and to count the number of pulses contained in the timing signal, and may be configured to output the trigger signal having applied the first delay time to the timing signal so that the pulse laser beam is focused at the plasma generation region at a timing shifted from an arrival timing at which the target arrives at the plasma generation region from when the predetermined time starts to when the number of pulses reaches a predetermined value, and to output the trigger signal having applied the second delay time to the timing signal so that the pulse laser beam is focused at the plasma generation region at the arrival timing at which the target arrives at the plasma generation region from when the number of pulses reaches the predetermined value to when the predetermined time ends.

An extreme ultraviolet light generation system according to another aspect of the present disclosure may include a laser device, a chamber, a target supply device, a focusing optical system, a deflecting device, and a control unit. The laser device may be configured to output a pulse laser beam. The chamber may be provided with at least one opening for introducing the pulse laser beam. The target supply device may be configured to supply a plurality of targets consecutively to the interior of the chamber. The focusing optical system may be configured to focus the pulse laser beam at a plasma generation region. The deflecting device may be configured to cause a trajectory of the target supplied by the target supply device to approximately match one of a first trajectory in which the target passes through the plasma generation region and a second trajectory in which the target passes outside the plasma generation region. The control unit may be configured to output, to the laser device, a trigger signal obtained by applying a predetermined delay time to a timing signal indicating a timing at which the target is to be supplied by the target supply device so that the laser device outputs the pulse laser beam throughout a predetermined time, to count the number of pulses contained in the timing signal, and to output a control signal to the deflecting device so that the deflecting device sets the trajectory of the target to the second trajectory from when the predetermined time starts to when the number of pulses reaches a predetermined value and sets the trajectory of the target to the first trajectory from when the number of pulses reaches the predetermined value to when the predetermined time ends.

An extreme ultraviolet light generation system according to another aspect of the present disclosure may include a laser device, a chamber, a target supply device, a focusing optical system, an optical device, and a control unit. The laser device may be configured to output a pulse laser beam. The chamber may be provided with at least one opening for introducing the pulse laser beam. The target supply device may be configured to supply a plurality of targets consecutively to a plasma generation region within the chamber. The focusing optical system may be configured to focus the pulse laser beam. The optical device may be configured to cause an optical path of the pulse laser beam to approximately match one of a first optical path in which the pulse laser beam is focused at the plasma generation region and a second optical path in which the pulse laser beam passes outside the plasma generation region. The control unit may be configured to output, to the laser device, a trigger signal obtained by applying a predetermined delay time to a timing signal indicating a timing at which the target is to be supplied by the target supply device so that the laser device outputs the pulse laser beam throughout a first predetermined time, to measure a second predetermined time that is shorter than the first predetermined time, and to output a control signal to the optical device so that the optical device sets the optical path of the pulse laser beam to the second optical path from when the first predetermined time starts to when the second predetermined time ends and sets the optical path of the pulse laser beam to the first optical path from when the second predetermined time ends to when the first predetermined time ends.

An extreme ultraviolet light generation system according to another aspect of the present disclosure may include a laser device, a chamber, a target supply device, a focusing optical system, and a control unit. The laser device may be configured to output a pulse laser beam. The chamber may be provided with at least one opening for introducing the pulse laser beam. The target supply device may be configured to supply a plurality of targets consecutively to a plasma generation region within the chamber. The focusing optical system may be configured to focus the pulse laser beam at the plasma generation region. The control unit may be configured to output, to the laser device, a trigger signal obtained by applying one of a first delay time and a second delay time to a timing signal indicating a timing at which the target is to be supplied by the target supply device so that the laser device outputs the pulse laser beam throughout a first predetermined time, and to measure a second predetermined time that is shorter than the first predetermined time, and may be configured to output the trigger signal having applied the first delay time to the timing signal so that the pulse laser beam is focused at the plasma generation region at a timing shifted from an arrival timing at which the target arrives at the plasma generation region from when the first predetermined time starts to when the second predetermined time ends, and to output the trigger signal having applied the second delay time to the timing signal so that the pulse laser beam is focused at the plasma generation region at the arrival timing at which the target arrives at the plasma generation region from when the second predetermined time ends to when the first predetermined time ends.

An extreme ultraviolet light generation system according to another aspect of the present disclosure may include a laser device, a chamber, a target supply device, a focusing optical system, a deflecting device, and a control unit. The laser device may be configured to output a pulse laser beam. The chamber may be provided with at least one opening for introducing the pulse laser beam. The target supply device may be configured to supply a plurality of targets consecutively to the interior of the chamber. The focusing optical system may be configured to focus the pulse laser beam at a plasma generation region. The deflecting device may be configured to cause a trajectory of the target supplied by the target supply device to approximately match one of a first trajectory in which the target passes through the plasma generation region and a second trajectory in which the target passes outside the plasma generation region. The control unit may be configured to output, to the laser device, a trigger signal obtained by applying a predetermined delay time to a timing signal indicating a timing at which the target is to be supplied by the target supply device so that the laser device outputs the pulse laser beam throughout a first predetermined time, to measure a second predetermined time that is shorter than the first predetermined time, and to output a control signal to the deflecting device so that the deflecting device sets the trajectory of the target to the second trajectory from when the first predetermined time starts to when the second predetermined time ends and sets the trajectory of the target to the first trajectory from when the second predetermined time ends to when the first predetermined time ends.

### BRIEF DESCRIPTION OF THE DRAWINGS

Hereinafter, selected embodiments of the present disclosure will be described with reference to the accompanying drawings.

FIG. 1 schematically illustrates an exemplary configuration of an LPP type EUV light generation system.

FIG. 2A is a partial cross-sectional view illustrating an EUV light generation system according to a first embodiment.

FIG. 2B is a cross-sectional view illustrating the EUV light generation system along a IIB-IIB line shown in FIG. 2A.

FIG. 3 is a block diagram illustrating an EUV light generation controller and a laser apparatus shown in FIG. 2A.

FIG. 4 illustrates an example of the configuration of an optical shutter shown in FIG. 3.

FIGS. 5A to 5F are timing charts illustrating signals from respective constituent elements shown in FIG. 3 and EUV light generated by an EUV light generation system.

FIG. 6 is a block diagram illustrating an EUV light generation controller in an EUV light generation system according to a second embodiment.

FIG. 7 illustrates positions of a target when detecting a target, and when focusing a pulse laser beam in the case where first and second delay times have been set.

FIGS. 8A to 8F are timing charts illustrating signals from respective constituent elements shown in FIG. 6 and EUV light generated by an EUV light generation system.

FIG. 9 is a partial cross-sectional view illustrating an EUV light generation controller, a target supply device, and a deflecting device in an EUV light generation system according to a third embodiment.

FIGS. 10A to 10F are timing charts illustrating signals from respective constituent elements shown in FIG. 9 and EUV light generated by an EUV light generation system.

FIG. 11 is a block diagram illustrating an EUV light generation controller and a laser apparatus in an EUV light generation system according to a fourth embodiment.

FIG. 12 is a block diagram illustrating an EUV light generation controller and a laser apparatus in an EUV light generation system according to a fifth embodiment.

FIG. 13 is a partial cross-sectional view illustrating an EUV light generation controller, a laser apparatus, and a target supply device in an EUV light generation system according to a sixth embodiment.

FIG. 14 is a block diagram illustrating an EUV light generation controller and a laser apparatus in an EUV light generation system according to a seventh embodiment.

### DETAILED DESCRIPTION

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein.

### Contents

### 1. Overview

### 2. Terms

### 3. Overview of EUV Light Generation System

### 3.1 Configuration

### 3.2 Operation

4. EUV Light Generation System that Changes Optical Path of Pulse Laser Beam

### 4.1 Overview of Configuration

4.2 Configuration that Changes Optical Path

### 4.3 Details of Optical Shutter

### 4.4 Effect

5. EUV Light Generation System that Changes Output Timing of Pulse Laser Beam
6. EUV Light Generation System that Changes Trajectory of Target
7. EUV Light Generation System that Changes Optical Path of Pre-pulse Laser Beam
8. EUV Light Generation System that Changes Output Timing of Pre-pulse Laser Beam
9. EUV Light Generation System that Supplies Targets On Demand

### 10. EUV Light Generation System Including Timer

### 1. Overview

In an LPP type EUV light generation system, a target supply device may output a target and cause the target to reach a plasma generation region within a chamber. By a laser device irradiating the target with a pulse laser beam at the point in time when the target reaches the plasma generation region, the target can be turned into plasma and EUV light can be radiated from the plasma.

In the EUV light generation system, it can be required that EUV light be generated over a predetermined time at a predetermined repetition rate (for example, 100 kHz). The target supply device may output the targets at the stated predetermined repetition rate in order for the EUV light generation system to generate the EUV light at the predetermined repetition rate. The laser device may output the pulse laser beam in accordance with the timing at which the targets are supplied. A repetition rate of the pulse laser beam outputted by the laser device can be the same as the stated predetermined repetition rate. Outputting the pulse laser beam at the predetermined repetition rate throughout the predetermined time in this manner is sometimes referred to as “bursts”.

The inventors of the present disclosure discovered that when a laser device generates bursts, the energy level of the pulse laser beam can be unstable at the beginning of the respective bursts. If a target is then irradiated with a pulse laser beam whose energy level is unstable in this manner, a problem in which the target is not sufficiently turned into plasma can arise. In other words, the percentage of the target that is ionized (an ionization rate) can drop, and a percentage of electrically neutral debris can rise. The electrically neutral debris can be vapor, clusters, fine liquid droplets, and the like.

According to an aspect of the present disclosure, an optical path of the pulse laser beam may be set to an optical path that passes outside the plasma generation region at the beginning of the respective bursts.

According to another aspect of the present disclosure, the pulse laser beam may be focused at the plasma generation region at a timing that is shifted from the timing at which the target reaches the plasma generation region at the beginning of the respective bursts.

According to yet another aspect of the present disclosure, a trajectory of the target may be set to a trajectory that passes outside the plasma generation region at the beginning of the respective pulse laser beam bursts.

According to this configuration, the pulse laser beam can be suppressed from striking the targets at the beginning of the respective bursts, and thus electrically neutral debris can be suppressed from being produced.

### 2. Terms

Several terms used in the present application will be described hereinafter.

A “trajectory” of a target may be an ideal path of a target outputted from a target supply device, or may be a path of a target according to the design of a target supply device.

The “trajectory” of the target may also be the actual path of the target outputted from the target supply device.

A “plasma generation region” can refer to a region where the generation of plasma for generating EUV light begins. It can be necessary for a target to be supplied to the plasma generation region and for a pulse laser beam to be focused at the plasma generation region at the timing at which the target reaches the plasma generation region in order for the generation of plasma to begin at the plasma generation region.

### 3. Overview of EUV Light Generation System

### 3.1 Configuration

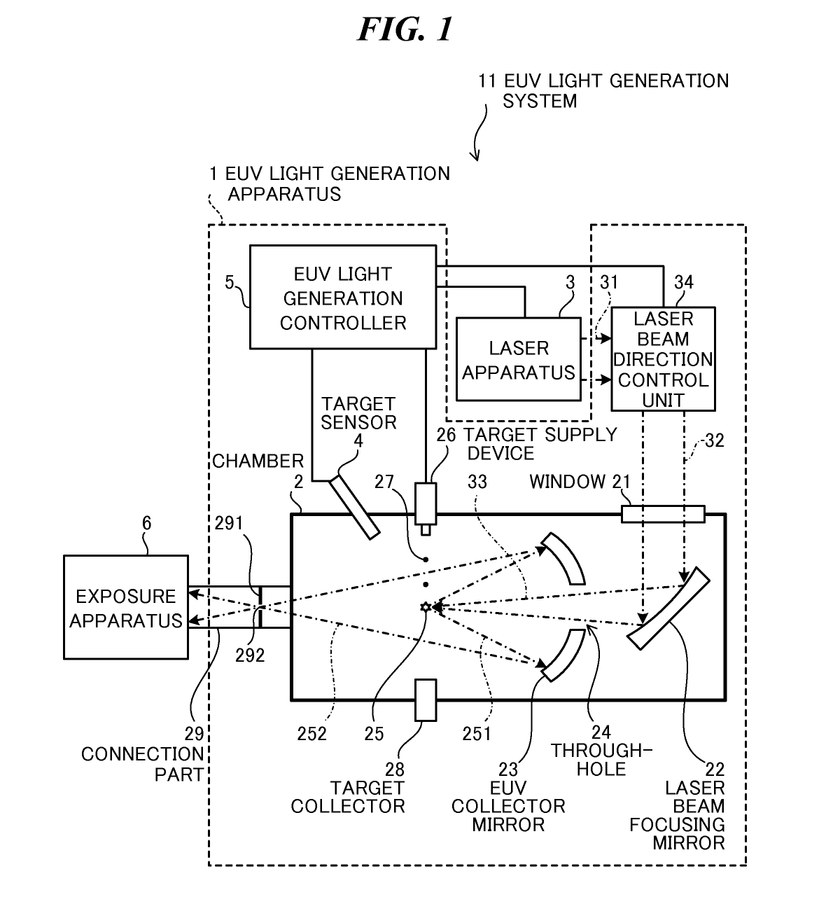

FIG. 1 schematically illustrates an exemplary configuration of an LPP type EUV light generation system. An EUV light generation apparatus 1 may be used with at least one laser apparatus 3. Hereinafter, a system that includes the EUV light generation apparatus 1 and the laser apparatus 3 may be referred to as an EUV light generation system 11. As shown in FIG. 1 and described in detail below, the EUV light generation system 11 may include a chamber 2 and a target supply device 26. The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or any combination thereof.

The chamber 2 may have at least one through-hole or opening formed in its wall, and a pulse laser beam 32 may travel through the through-hole/opening into the chamber 2. Alternatively, the chamber 2 may have a window 21, through which the pulse laser beam 32 may travel into the chamber 2. An EUV collector mirror 23 having a spheroidal surface may, for example, be provided in the chamber 2. The EUV collector mirror 23 may have a multi-layered reflective film formed on the spheroidal surface thereof. The reflective film may include a molybdenum layer and a silicon layer, which are alternately laminated. The EUV collector mirror 23 may have a first focus and a second focus, and may be positioned such that the first focus lies in a plasma generation region 25 and the second focus lies in an intermediate focus (IF) region 292 defined by the specifications of an external apparatus, such as an exposure apparatus 6. The EUV collector mirror 23 may have a through-hole 24 formed at the center thereof so that a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, trajectory, position, and speed of a target 27.

Further, the EUV light generation system 11 may include a connection part 29 for allowing the interior of the chamber 2 to be in communication with the interior of the exposure apparatus 6. A wall 291 having an aperture 293 may be provided in the connection part 29. The wall 291 may be positioned such that the second focus of the EUV collector mirror 23 lies in the aperture 293 formed in the wall 291.

The EUV light generation system 11 may also include a laser beam direction control unit 34, a laser beam focusing mirror 22, and a target collector 28 for collecting targets 27. The laser beam direction control unit 34 may include an optical element (not separately shown) for defining the direction into which the pulse laser beam 32 travels and an actuator (not separately shown) for adjusting the position and the orientation or posture of the optical element.

### 3.2 Operation

With continued reference to FIG. 1, a pulse laser beam 31 outputted from the laser apparatus 3 may pass through the laser beam direction control unit 34 and be outputted therefrom as the pulse laser beam 32 after having its direction optionally adjusted. The pulse laser beam 32 may travel through the window 21 and enter the chamber 2. The pulse laser beam 32 may travel inside the chamber 2 along at least one beam path from the laser apparatus 3, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 including EUV light may be emitted from the plasma. At least the EUV light included in the light 251 may be reflected selectively by the EUV collector mirror 23. EUV light 252, which is the light reflected by the EUV collector mirror 23, may travel through the intermediate focus region 292 and be outputted to the exposure apparatus 6. Here, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of: the timing when the target 27 is outputted and the direction into which the target 27 is outputted. Furthermore, the EUV light generation controller 5 may be configured to control at least one of: the timing when the laser apparatus 3 oscillates, the direction in which the pulse laser beam 33 travels, and the position at which the pulse laser beam 33 is focused. It will be appreciated that the various controls mentioned above are merely examples, and other controls may be added as necessary.

4. EUV Light Generation System that Changes Optical Path of Pulse Laser Beam

### 4.1 Overview of Configuration

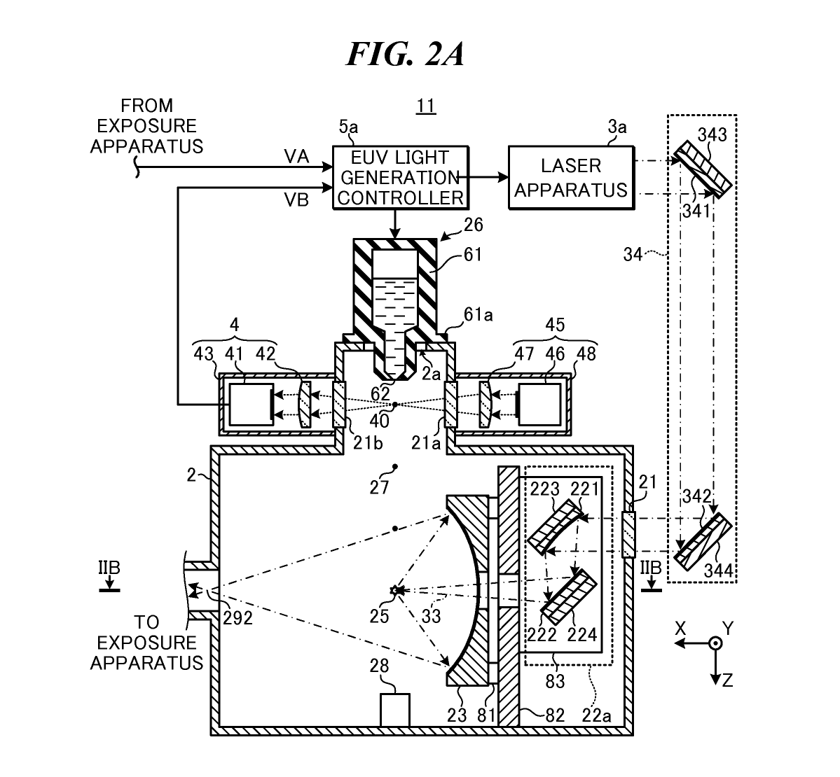

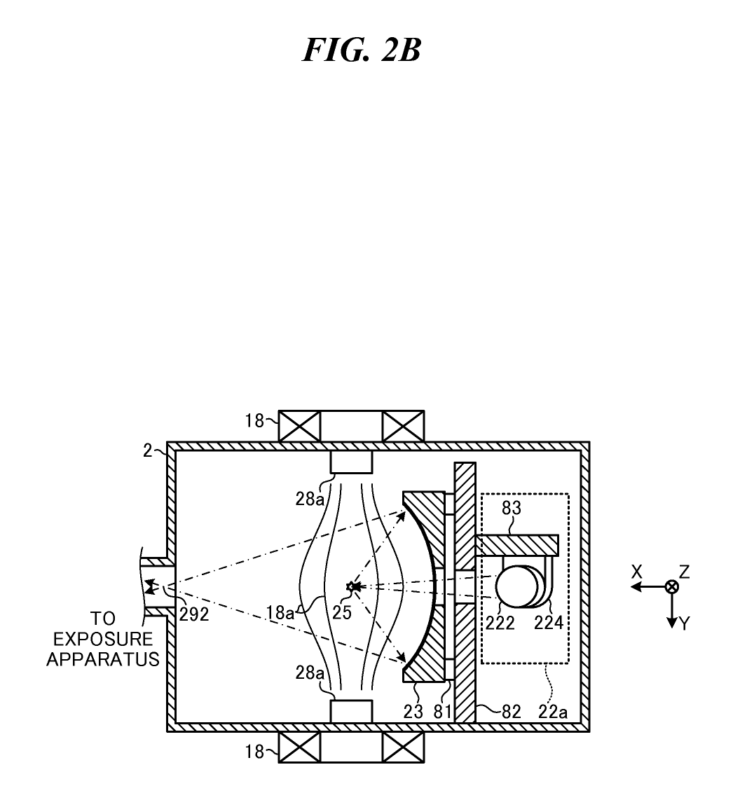

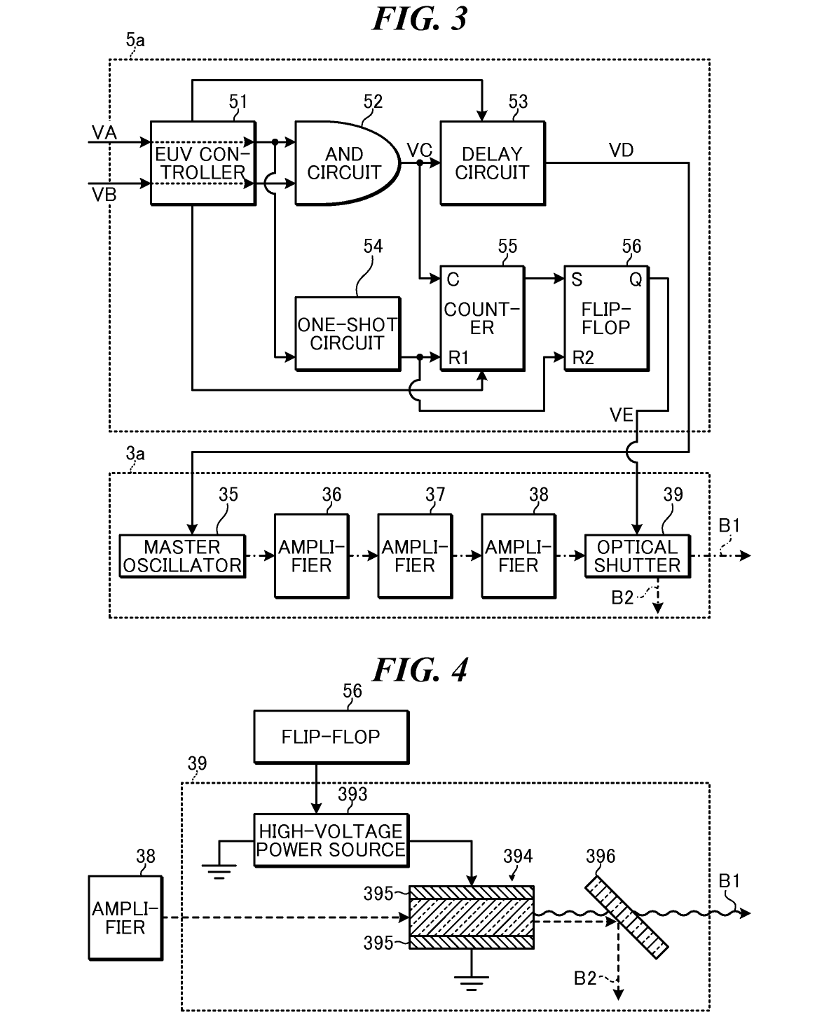

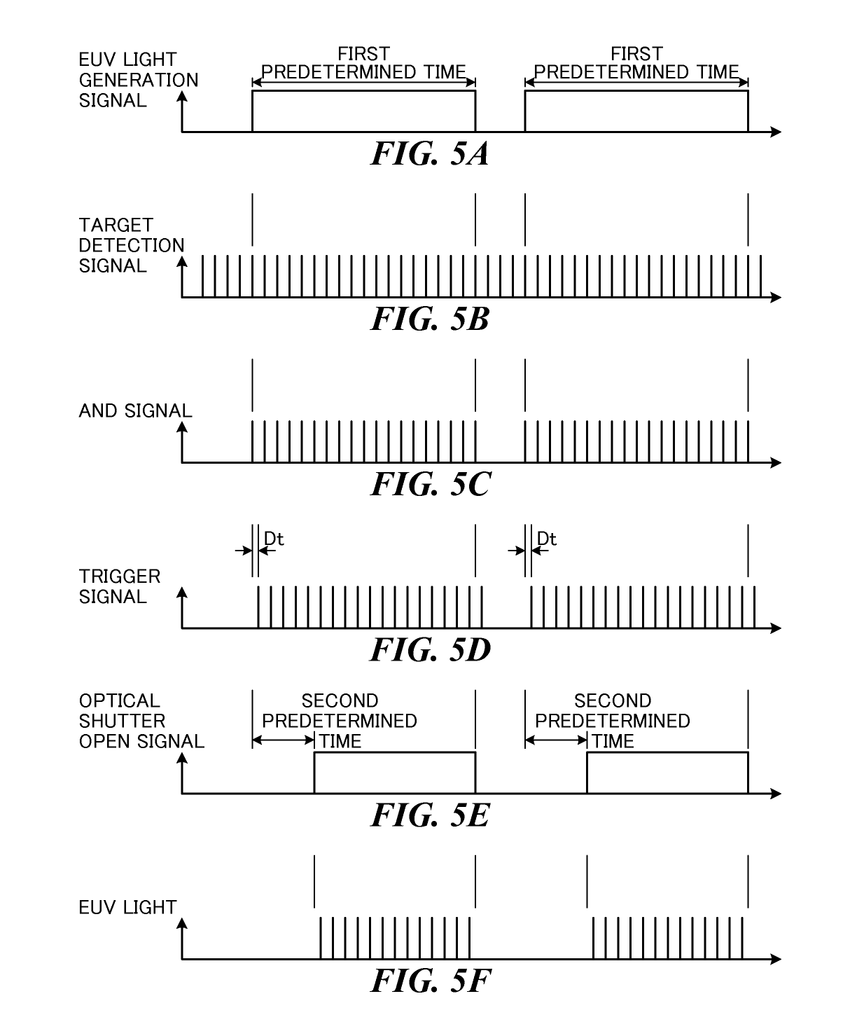

FIG. 2A is a partial cross-sectional view illustrating an EUV light generation system according to a first embodiment. FIG. 2B is a cross-sectional view illustrating the EUV light generation system along a IIB-IIB line shown in FIG. 2A. FIG. 3 is a block diagram illustrating an EUV light generation controller and a laser apparatus shown in FIG. 2A. FIG. 4 illustrates an example of the configuration of an optical shutter shown in FIG. 3. FIGS. 5A to 5F are timing charts illustrating signals from respective constituent elements shown in FIG. 3 and EUV light generated by an EUV light generation system.

As shown in FIG. 2A, a laser beam focusing optical system 22a, the EUV collector mirror 23, the target collector 28, an EUV collector mirror holder 81, and plates 82 and 83 may be provided within the chamber 2.

The plate 82 may be anchored to the chamber 2. The plate 83 may be anchored to the plate 82. The EUV collector mirror 23 may be anchored to the plate 82 via the EUV collector mirror holder 81.

The laser beam focusing optical system 22a may include an off-axis paraboloid mirror 221, a flat mirror 222, and holders 223 and 224. The off-axis paraboloid mirror 221 and the flat mirror 222 may be held by the holders 223 and 224, respectively. The holders 223 and 224 may be anchored to the plate 83. The positions and orientations of the off-axis paraboloid mirror 221 and the flat mirror 222 may be held so that the pulse laser beam 33 reflected by those mirrors is focused at the plasma generation region 25. The target collector 28 may be disposed upon a straight line extending from the trajectory of the target 27.

The target supply device 26 may be attached to the chamber 2. The target supply device 26 may include a reservoir 61. The reservoir 61 may hold a target material that has been melted using a heater (not shown). An opening 62 may be formed in the reservoir 61. Part of the reservoir 61 may be inserted into a through-hole 2a formed in a wall surface of the chamber 2 so that the opening 62 formed in the reservoir 61 is positioned inside the chamber 2. The target supply device 26 may supply the melted target material to the plasma generation region 25 within the chamber 2 as droplet-shaped targets 27 via the opening 62. A flange portion 61a of the reservoir 61 may be tightly fitted and anchored to the wall surface of the chamber 2 in the periphery of the through-hole 2a.

The target sensor 4 and a light-emitting section 45 may be attached to the chamber 2. The target sensor 4 may include a photodetector 41, a focusing optical system 42, and a receptacle 43. The receptacle 43 may be anchored to the outside of the chamber 2, and the photodetector 41 and the focusing optical system 42 may be anchored within the receptacle 43. The light-emitting section 45 may include a light source 46, a focusing optical system 47, and a receptacle 48. The receptacle 48 may be anchored to the outside of the chamber 2, and the light source 46 and the focusing optical system 47 may be anchored within the receptacle 48. Light outputted from the light source 46 can be focused by the focusing optical system 47. The focal position of the outputted light may be located substantially upon the trajectory of the targets 27.

The target sensor 4 and the light-emitting section 45 may be disposed opposite to each other on either side of the trajectory of the targets 27. Windows 21a and 21b may be provided in the chamber 2. The window 21a may be positioned between the light-emitting section 45 and the trajectory of the targets 27. The light-emitting section 45 may focus light at a predetermined position in the trajectory of the targets 27 via the window 21a. The window 21b may be positioned between the trajectory of the targets 27 and the target sensor 4. When the target 27 passes through the focal position of the light emitted from the light-emitting section 45, the target sensor 4 may detect a change in the light passing through the trajectory of the target 27 and the vicinity thereof and may output a target detection signal VB. As shown in FIG. 5B, a single pulse may be outputted as the target detection signal VB each time a single target 27 is detected. In this example, the target detection signal VB may serve as a timing signal indicating a supply timing of the targets.

A position of the center of the target 27 detected by the target sensor 4 will be referred to as a target detection position 40 in the following descriptions. In the example shown in FIG. 2A, the target detection position 40 can substantially match the focal position of the light emitted from the light-emitting section 45.

The laser beam direction control unit 34 and an EUV light generation controller 5a may be provided outside the chamber 2. The laser beam direction control unit 34 may include high-reflecting mirrors 341 and 342, as well as holders 343 and 344. The high-reflecting mirrors 341 and 342 may be held by the holders 343 and 344, respectively.

In the case where the exposure apparatus 6 (see FIG. 1) has outputted an EUV light generation signal VA, the EUV light generation controller 5a may receive that EUV light generation signal VA. The EUV light generation signal VA may be a signal instructing the EUV light generation system 11 to generate EUV light during a first predetermined time. As shown in FIG. 5A, the EUV light generation signal VA can take on a high potential (ON) or a low potential (OFF). The EUV light generation signal VA may be a signal that is ON during the first predetermined time in which EUV light is to be generated and is OFF during a time after the first predetermined time has ended and EUV light need not be generated.

As shown in FIG. 2B, a magnetic field generator 18 may be provided outside the chamber 2. The magnetic field generator 18 may include a pair of magnets. These magnets may be electromagnets having toroidal coils. The magnetic field generator 18 may be disposed so that center axes of the coils are substantially orthogonal to the direction in which the targets 27 travel. The magnetic field generator 18 may be configured to form a magnetic field 18a within the chamber 2. The magnetic field 18a may be axially symmetrical with respect to the center axis of the two coils in the magnetic field generator 18. It is preferable for the magnetic field 18a to be formed in the periphery of the plasma generation region 25.

The plasma generated at the plasma generation region 25 can contain ions of the target material (tin or the like) (positive ions such as Sn²⁺) and electrons. In the case where there is no magnetic field 18a, the ions and electrons can diffuse radially from the plasma generation region 25.

When the ions and electrons attempt to move within the magnetic field formed by the magnetic field generator 18, the ions and electrons can come under a Lorentz force based on the direction of the magnetic field, the movement directions of the ions and electrons, and the charges of the ions and electrons. As a result, the ions and electrons contained in the plasma can move in spirals along the magnetic field under the Lorentz force, and can be collected by an ion collector 28a.

Through this, the ions and electrons can be suppressed from scattering toward the EUV collector mirror 23. Accordingly, the EUV collector mirror 23 can be suppressed from being contaminated by the ions and electrons.

4.2 Configuration that Changes Optical Path

As shown in FIG. 3, the EUV light generation controller 5a may include an EUV controller 51, an AND circuit 52, a delay circuit 53, a one-shot circuit 54, a counter 55, and a flip-flop 56. The counter 55 may include a signal input terminal C and a reset input terminal R1. The flip-flop 56 may include a set input terminal S, a reset input terminal R2, and an output terminal Q.

A laser apparatus 3a may include a master oscillator 35 and first, second, and third amplifiers 36, 37, and 38. The master oscillator 35 and the first to third amplifiers 36, 37, and 38 may be connected in series. A pulse laser beam generated by the master oscillator 35 may be amplified by the amplifier 36. The pulse laser beam amplified by and outputted from the amplifier 36 may be further amplified by the amplifier 37, and the pulse laser beam amplified by and outputted from the amplifier 37 may be further amplified by the amplifier 38.

The laser apparatus 3a may include an optical shutter 39 as an optical device. The optical shutter 39 may be disposed in, for example, the optical path of the pulse laser beam amplified by and outputted from the amplifier 38. This optical path can be an optical path between the amplifier 38 and the plasma generation region 25. Alternatively, the optical shutter may be disposed in the optical path of the pulse laser beam between the master oscillator 35 and the amplifier 36, between the amplifier 36 and the amplifier 37, or between the amplifier 37 and the amplifier 38 (this is not shown).

The optical shutter 39 may switch the optical path of the pulse laser beam between a first optical path B1 and a second optical path B2. The first optical path B1 may be an optical path through which the pulse laser beam is focused at the plasma generation region 25. The second optical path B2 may be an optical path through which the pulse laser beam passes outside the plasma generation region 25 and is collected in a laser dumper (not shown). The optical shutter 39 may open and close the optical path to the plasma generation region 25 by switching between the optical path B1 and the optical path B2 for the pulse laser beam in this manner.

The EUV controller 51 may output the EUV light generation signal VA outputted by the exposure apparatus 6 to the AND circuit 52 and the one-shot circuit 54. The EUV controller 51 may output the target detection signal VB outputted by the target sensor 4 to the AND circuit 52. The EUV controller 51 may output, to the delay circuit 53, a control signal containing setting information for a delay time Dt. The delay time Dt will be described later. The EUV controller 51 may output, to the counter 55, a control signal containing information of a set count number (for example, 20 pulses).

The AND circuit 52 may receive the EUV light generation signal VA outputted by the exposure apparatus 6 and the target detection signal VB outputted by the target sensor 4 via the EUV controller 51. The AND circuit 52 may generate an AND signal VC of the received EUV light generation signal VA and target detection signal VB. As shown in FIG. 5C, the AND signal VC can be a signal that is equal to the target detection signal VB outputted during a period when the EUV light generation signal VA is ON. The AND circuit 52 may output this AND signal VC to the delay circuit 53 and the signal input terminal C of the counter 55.

The delay circuit 53 may receive the AND signal VC of the EUV light generation signal VA and the target detection signal VB from the AND circuit 52. The delay circuit 53 may generate a trigger signal VD based on the AND signal VC, and may output the trigger signal VD to the master oscillator 35. As shown in FIG. 5D, the trigger signal VD may be a signal obtained by applying the delay time Dt set by the EUV controller 51 to the AND signal VC.

The delay time Dt can be a delay time that causes the pulse laser beam to be focused at the plasma generation region 25 at the timing at which the target 27 detected by the target sensor 4 reaches the plasma generation region 25. The delay time Dt can be applied using the following formula, for example.

Dt=L/v−α

Here, “L” may represent a distance from the target detection position 40 to a center position of the plasma generation region 25. “v” may represent a velocity of the target. “α” may represent an amount of time from when the trigger signal VD is outputted to when the pulse laser beam is focused at the plasma generation region 25.

The one-shot circuit 54 may receive the EUV light generation signal VA outputted from the exposure apparatus 6 via the EUV controller 51. The one-shot circuit 54 may detect a trailing edge of the EUV light generation signal VA and generate a pulse signal indicating the timing at which the trailing edge has been detected. In other words, the one-shot circuit 54 may generate a pulse signal at the timing at which the EUV light generation signal VA changes from ON to OFF. The one-shot circuit 54 may output the pulse signal to the reset input terminal R1 of the counter 55 and the reset input terminal R2 of the flip-flop 56.

The signal input terminal C of the counter 55 may receive the AND signal VC of the EUV light generation signal VA and the target detection signal VB from the AND circuit 52. The counter 55 may count the number of pulses contained in the AND signal VC until the number of pulses contained in the AND signal VC reaches the set count number set by the EUV controller 51. By counting the number of pulses contained in the AND signal VC, the counter 55 can substantially count the number of pulses contained in the target detection signal VB after the EUV light generation signal VA has changed to ON. Furthermore, by counting the number of pulses contained in the AND signal VC, the counter 55 can substantially measure a second predetermined time.

The counter 55 may stop the count and generate an output pulse signal when the number of pulses contained in the AND signal VC has reached the set count number. The counter 55 may output this output pulse signal to the set input terminal S of the flip-flop 56.

The reset input terminal R1 of the counter 55 may receive, from the one-shot circuit 54, the pulse signal indicating the timing at which the trailing edge of the EUV light generation signal VA has been detected. In the case where the reset input terminal R1 has received the pulse signal, the counter 55 may reset the counted number of pulses, and may then begin counting the number of pulses contained in the AND signal VC received by the signal input terminal C anew. Operations performed by the counter 55 when the number of pulses contained in the AND signal VC has reached the set count number may be as described above.

The set input terminal S of the flip-flop 56 may receive, from the counter 55, the output pulse signal indicating that the number of pulses contained in the AND signal VC has reached the set count number. The reset input terminal R2 of the flip-flop 56 may receive, from the one-shot circuit 54, the pulse signal indicating the timing at which the trailing edge of the EUV light generation signal VA has been detected.

The output terminal Q of the flip-flop 56 may output an optical shutter open signal VE (see FIG. 5E) to the optical shutter 39. The optical shutter open signal VE can be a high potential (ON) or a low potential (OFF). The flip-flop 56 may set the optical shutter open signal VE to ON during the period from when the set input terminal S has received the output pulse signal to when the reset input terminal R2 has received the pulse signal. The flip-flop 56 may set the optical shutter open signal VE to OFF during the period from when the reset input terminal R2 has received the pulse signal to when the set input terminal S has received the output pulse signal.

In other words, the optical shutter open signal VE may be OFF from when the output of the AND signal VC is started to when the number of pulses contained in the AND signal VC reaches the set count number (that is, during the second predetermined time). The optical shutter open signal VE may be ON during a period from when the number of pulses contained in the AND signal VC has reached the set count number to the timing at which the EUV light generation signal VA falls. The optical shutter open signal VE may once again change to OFF at the timing at which the EUV light generation signal VA falls.

The optical shutter 39 may receive the optical shutter open signal VE from the flip-flop 56 of the EUV light generation controller 5a. The optical shutter 39 may set the optical path of the pulse laser beam to the first optical path B1 in the case where the optical shutter open signal VE is ON. In this case, the pulse laser beam may strike the target 27 and generate EUV light as shown in FIG. 5F. The optical shutter 39 may set the optical path of the pulse laser beam to the second optical path B2 in the case where the optical shutter open signal VE is OFF. In this case, the pulse laser beam may not strike the target 27, and EUV light may not be generated.

### 4.3 Details of Optical Shutter

As shown in FIG. 4, the optical shutter 39 may include a high-voltage power source 393, a Pockels cell 394, and a polarizer 396. The Pockels cell 394 may include a pair of electrodes 395 provided facing each other with an electro-optic crystal positioned therebetween.

The high-voltage power source 393 may receive the optical shutter open signal VE from the flip-flop 56 of the EUV light generation controller 5a. The high-voltage power source 393 may generate a predetermined voltage (a voltage that is not 0 V) in the case where the optical shutter open signal VE is ON and apply that voltage to the pair of electrodes 395 in the Pockels cell 394. The high-voltage power source 393 may set the voltage applied to the pair of electrodes 395 in the Pockels cell 394 to 0 V in the case where the optical shutter open signal VE is OFF.

The pulse laser beam outputted from the amplifier 38 of the laser apparatus 3a may be a linearly-polarized beam whose polarization direction is perpendicular relative to the depiction in FIG. 4. The pulse laser beam outputted from the amplifier 38 may pass between the pair of electrodes 395. When a voltage is applied between the pair of electrodes 395, the Pockels cell 394 may change the phase difference of the polarized light components perpendicular to the pulse laser beam by 180 degrees (that is, rotate the polarization direction 90 degrees) and allow the beam to pass. However, when a voltage is not applied between the pair of electrodes 395, the Pockels cell 394 may allow the beam to pass without changing the phase difference of the polarized light components perpendicular to the pulse laser beam.

The polarizer 396 may allow a pulse laser beam that is a linearly-polarized beam whose polarization direction is parallel relative to the depiction in FIG. 4 to pass through at a high level of transmissibility. In other words, in the case where the optical shutter open signal VE received from the flip-flop 56 is ON, the polarizer 396 may allow the pulse laser beam whose polarization direction has been rotated by the Pockels cell 394 to pass therethrough. Through this, the optical path of the pulse laser beam can become the first optical path B1.

The polarizer 396 may reflect the pulse laser beam that is a linearly-polarized beam whose polarization direction is perpendicular relative to the depiction in FIG. 4 at a high level of reflectance. In other words, in the case where the optical shutter open signal VE received from the flip-flop 56 is OFF, the polarizer 396 may reflect the pulse laser beam that has passed through the Pockels cell 394 without the polarization direction of the beam being rotated. Through this, the optical path of the pulse laser beam can become the second optical path B2.

### 4.4 Effect

According to the first embodiment, bursts can be generated throughout the first predetermined time by outputting the trigger signal VD to the master oscillator 35. However, at the beginning of the respective bursts (that is, throughout the second predetermined time), the pulse laser beam can be conducted to the outside of the plasma generation region 25. Accordingly, the targets 27 can be suppressed from being irradiated with a pulse laser beam whose energy level is unstable, and electrically neutral debris can be suppressed from being produced.

When the second predetermined time, which is shorter than the first predetermined time, has elapsed, the optical shutter open signal VE changes to ON and the pulse laser beam can be conducted to the plasma generation region 25. Through this, the targets 27 can be irradiated with a pulse laser beam whose energy level is stable, and EUV light whose energy level is stable can be generated as a result.

Furthermore, according to the first embodiment, the percentage of charged debris (ions and the like) that is produced can increase relatively as a result of the production of electrically neutral debris being suppressed. In other words, an ionization rate, provided by the following formula, can be increased.

(ionization rate)=(amount of charged debris)/(total debris amount)×100

As described above, the charged debris can be efficiently collected in the case where the magnetic field generator 18 (FIG. 2B) is provided outside the chamber 2. Accordingly, the EUV collector mirror 23 and the like can be suppressed from being contaminated by the debris.

Although the EUV light generation controller 5a includes logical circuits such as the one-shot circuit 54, the counter 55, and the flip-flop 56 in the first embodiment, the present disclosure is not limited thereto. The EUV light generation controller 5a may include an integrated circuit such as a flexible programmable gate array (FPGA) programmed to perform the same functions as the functions described above.

Although the optical shutter 39 includes the high-voltage power source 393, the Pockels cell 394, and the polarizer 396 in the first embodiment, the present disclosure is not limited thereto. The optical shutter 39 may include an acousto-optic element, a piezoelectric element, and a high-frequency power source (none of which are shown). The high-frequency power source may apply an AC voltage at a predetermined frequency to the piezoelectric element. The piezoelectric element may apply vibrations that are in accordance with the applied AC voltage to the acousto-optic element. The acousto-optic element may diffract a pulse laser beam in accordance with the applied vibrations. Through this, the optical path of the pulse laser beam may be switched between a first optical path in which the laser beam is focused at the plasma generation region 25 and a second optical path in which the laser beam passes outside the plasma generation region 25 and is absorbed by a laser dumper (not shown).

5. EUV Light Generation System that Changes Output Timing of Pulse Laser Beam

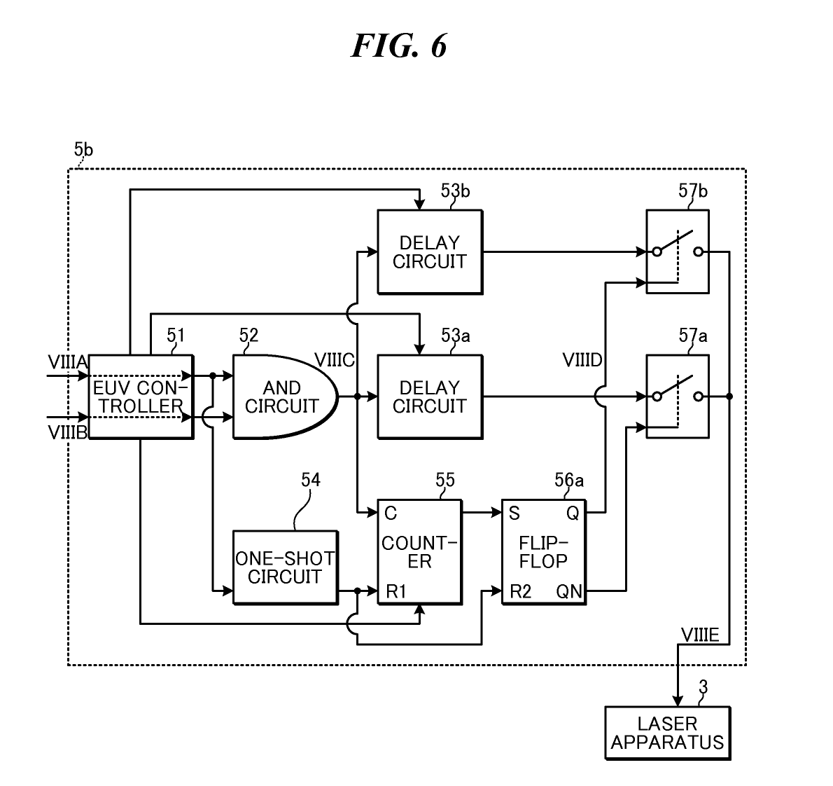

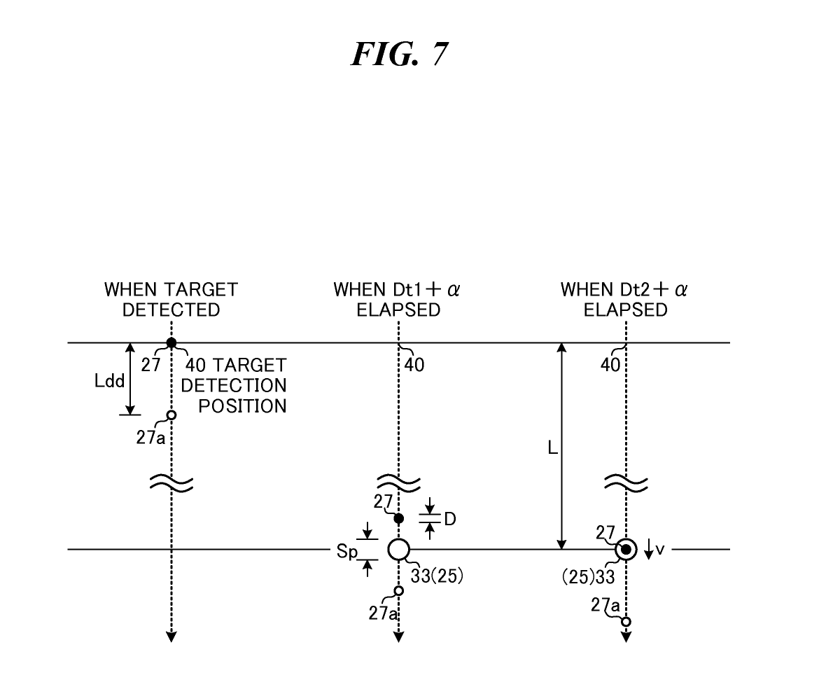

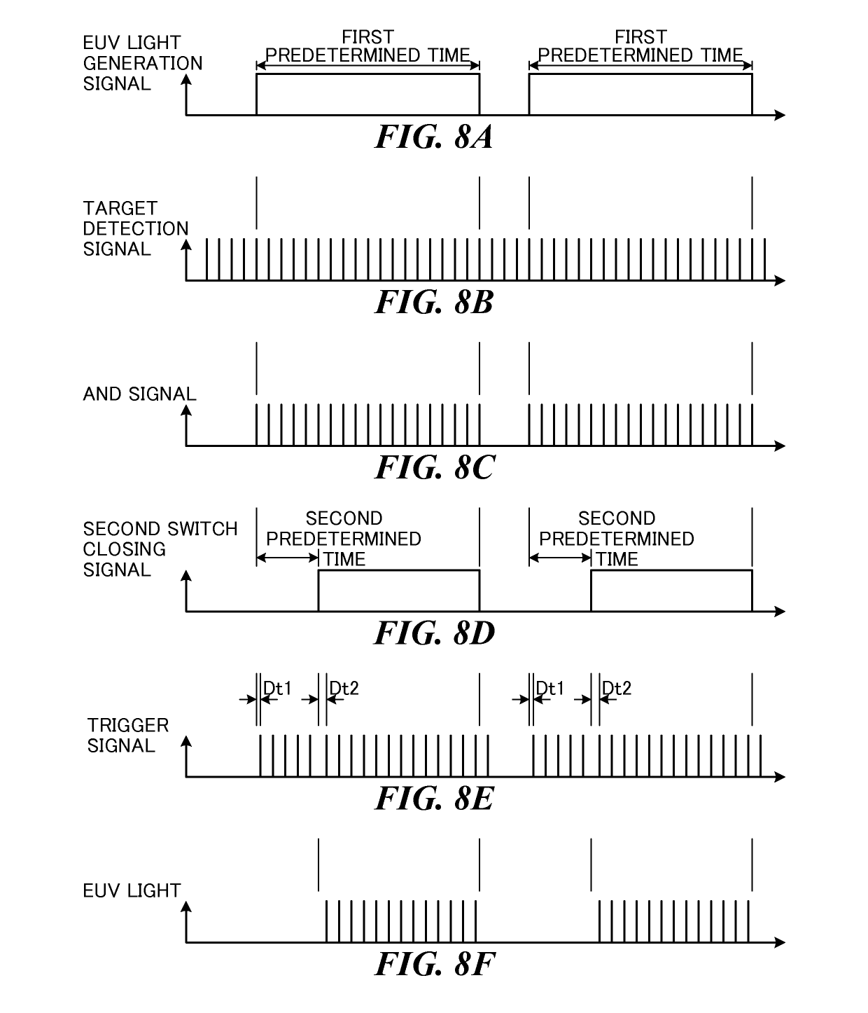

FIG. 6 is a block diagram illustrating an EUV light generation controller in an EUV light generation system according to a second embodiment. FIG. 7 illustrates the position of a target when detecting a target, and when focusing a pulse laser beam in the case where first and second delay times have been set. FIGS. 8A to 8F are timing charts illustrating signals from respective constituent elements shown in FIG. 6 and EUV light generated by the EUV light generation system.

An EUV light generation controller 5b may include the EUV controller 51, the AND circuit 52, a first delay circuit 53a, a second delay circuit 53b, the one-shot circuit 54, the counter 55, a flip-flop 56a, a first analog switch 57a, and a second analog switch 57b. The flip-flop 56a may include the set input terminal 5, the reset input terminal R2, the output terminal Q, and an inverting output terminal QN. The inverting output terminal QN may output a signal obtained by inverting the signal outputted from the output terminal Q.

The laser apparatus 3 may not include an optical shutter.

The configuration may be the same as that described in the first embodiment in other respects.

The EUV controller 51 may output, to the first delay circuit 53a, a control signal containing setting information for a first delay time Dt1. The first delay time Dt1 can be a delay time for focusing a pulse laser beam at the plasma generation region 25 when the target 27 is not present in the plasma generation region 25.

The EUV controller 51 may output, to the second delay circuit 53b, a control signal containing setting information for a second delay time Dt2. The second delay time Dt2 can be a delay time for focusing a pulse laser beam at the plasma generation region 25 at the timing at which the target 27 reaches the plasma generation region 25.

The AND circuit 52 may output an AND signal VIIIC of an EUV light generation signal VIIIA and a target detection signal VIIIB (see FIGS. 8A to 8C) to the first delay circuit 53a, the second delay circuit 53b, and the signal input terminal C of the counter 55. In this example, the target detection signal VIIIB may serve as a timing signal indicating a supply timing of the targets.

The first delay circuit 53a may receive the AND signal VIIIC of the EUV light generation signal VIIIA and the target detection signal VIIIB from the AND circuit 52 and may generate a first delay signal based on the AND signal VIIIC. The first delay signal may be a signal obtained by applying the first delay time Dt1 to the AND signal VIIIC. The first delay signal can serve as a trigger signal VIIIE during a second predetermined time indicated in FIG. 8E. The first delay circuit 53a may output the first delay signal to the first analog switch 57a.

The second delay circuit 53b may receive the AND signal VIIIC of the EUV light generation signal VIIIA and the target detection signal VIIIB from the AND circuit 52 and may generate a second delay signal based on the AND signal VIIIC. The second delay signal may be a signal obtained by applying the second delay time Dt2 to the AND signal VIIIC. The second delay signal can serve as a trigger signal VIIIE during a period, indicated in FIG. 8E, spanning from after the second predetermined time has elapsed to before the first predetermined time elapses. The second delay circuit 53b may output the second delay signal to the second analog switch 57b.

The inverting output terminal QN of the flip-flop 56a may output a first switch closing signal to the first analog switch 57a. The first switch closing signal can be a high potential (ON) or a low potential (OFF). The first switch closing signal may be OFF during a period from when the set input terminal S has received the output pulse signal to when the reset input terminal R2 receives the pulse signal. The first switch closing signal may be ON during a period from when the reset input terminal R2 has received the pulse signal to when the set input terminal S receives the output pulse signal.

The output terminal Q of the flip-flop 56a may output a second switch closing signal VIIID (see FIG. 8D) to the second analog switch 57b. The second switch closing signal VIIID can be a high potential (ON) or a low potential (OFF). The second switch closing signal VIIID may be ON during a period from when the set input terminal S has received the output pulse signal to when the reset input terminal R2 receives the pulse signal. The second switch closing signal VIIID may be OFF during a period from when the reset input terminal R2 has received the pulse signal to when the set input terminal S receives the output pulse signal.

The first analog switch 57a may receive the first switch closing signal outputted by the inverting output terminal QN of the flip-flop 56a. The first analog switch 57a may be closed in the case where the first switch closing signal is ON. In the case where the first analog switch 57a is closed, the first analog switch 57a may transfer the first delay signal outputted from the first delay circuit 53a to the laser apparatus 3 as the trigger signal VIIIE. The first analog switch 57a may be open in the case where the first switch closing signal is OFF. In the case where the first analog switch 57a is open, the first analog switch 57a may block the first delay signal from the laser apparatus 3.

The second analog switch 57b may receive the second switch closing signal VIIID outputted from the output terminal Q of the flip-flop 56a. The second analog switch 57b may be closed in the case where the second switch closing signal VIIID is ON. In the case where the second analog switch 57b is closed, the second analog switch 57b may transfer the second delay signal outputted from the second delay circuit 53b to the laser apparatus 3 as the trigger signal VIIIE. The second analog switch 57b may be open in the case where the second switch closing signal VIIID is OFF. In the case where the second analog switch 57b is open, the second analog switch 57b may block the second delay signal from the laser apparatus 3.

As shown in FIG. 8E, the first delay signal obtained by applying the first delay time Dt1 can be outputted to the laser apparatus 3 as the trigger signal VIIIE from when the output of the AND signal VIIIC has been started to when the second predetermined time has elapsed. When the second predetermined time elapses, the second delay signal obtained by applying the second delay time Dt2 can be outputted to the laser apparatus 3 as the trigger signal VIIIE.

Next, setting of the delay time will be described with reference to FIG. 7.

First, a case where the trigger signal VIIIE is generated by applying the second delay time Dt2 to the target detection signal VIIIB after the target 27 has been detected by the target sensor 4 will be considered. The second delay time Dt2 can be a delay time for focusing the pulse laser beam 33 on the target 27 at the plasma generation region 25. The second delay time Dt2 can be given using the following formula.

Dt2=L/v−α Formula 1

Here, “L” may represent a distance from the target detection position 40 to the plasma generation region 25. “v” may represent a velocity of the target. “α” may represent an amount of time from when the trigger signal VIIIE has been outputted to when the pulse laser beam 33 is focused. The pulse laser beam 33 can be focused at the timing at which the target 27 reaches the plasma generation region 25 by setting the second delay time Dt2 as indicated in the above Formula 1.

The first delay time Dt1 can be a delay time for focusing the pulse laser beam 33 between a plurality of targets 27 and 27a. A distance Ldd between a center position of the leading target 27a and the center position of the following target 27 can be defined through the following formula.

Ldd=v/f Formula 2

Here, “f” may represent a repetition rate of the targets supplied to the interior of the chamber 2.

Next, a case where the trigger signal VIIIE is generated by applying the first delay time Dt1 to the target detection signal VIIIB after the target 27 has been detected will be considered. The center position of the target 27 at the point in time when the pulse laser beam 33 generated based on the trigger signal VIIIE is focused can be a position separated from the target detection position 40 by a distance equivalent to (v·(Dt1+α)). At the same point in time, the center position of the leading target 27a can be a position separated from the target detection position 40 by a distance equivalent to (v·(Dt1+α)+Ldd). Conditions under which the plasma generation region 25 is positioned between the stated center positions can be defined through the following formulas.

v·(Dt1+α)<L

L<v·(Dt1+α)+Ldd

Accordingly, taking into consideration a beam diameter Sp of the pulse laser beam 33 at the plasma generation region 25 and a diameter D of the targets, conditions under which the target 27 or 27a is not irradiated with the pulse laser beam 33 can be defined by the following formulas.

v·(Dt1+α)+(Sp+D)/2<L Formula 3

L<v·(Dt1+α)−(Sp+D)/2+Ldd Formula 4

Based on the above Formulas 1 to 4, a range of the first delay time Dt1 can be defined through the following formulas.

Dt1<Dt2−(Sp+D)/2v Formula 5

Dt2+(Sp+D)/2v−1/f<Dt1 Formula 6

However, the following relational expression can be given as another condition under which the target 27 or 27a is not irradiated with the pulse laser beam 33.

Sp+D<Ldd

It is desirable for the value of the first delay time Dt1 to be the center value in the range defined by the above Formulas 5 and 6. This center value can be defined by the following formula.

Dt1=Dt2−½f

According to the second embodiment, bursts can be generated throughout the first predetermined time by outputting the trigger signal VIIIE to the master oscillator 35. However, at the beginning of the respective bursts (that is, throughout the second predetermined time), the pulse laser beam can be focused at the plasma generation region 25 at a timing that is shifted from the timing at which the target 27 reaches the plasma generation region 25. Accordingly, the targets 27 can be suppressed from being irradiated with a pulse laser beam whose energy level is unstable, and electrically neutral debris can be suppressed from being produced.

When the second predetermined time, which is shorter than the first predetermined time, elapses, the pulse laser beam can be focused at the plasma generation region 25 at the timing at which the target 27 reaches the plasma generation region 25. Through this, the targets 27 can be irradiated with a pulse laser beam whose energy level is stable, and EUV light whose energy level is stable can be generated as a result.

6. EUV Light Generation System that Changes Trajectory of Target

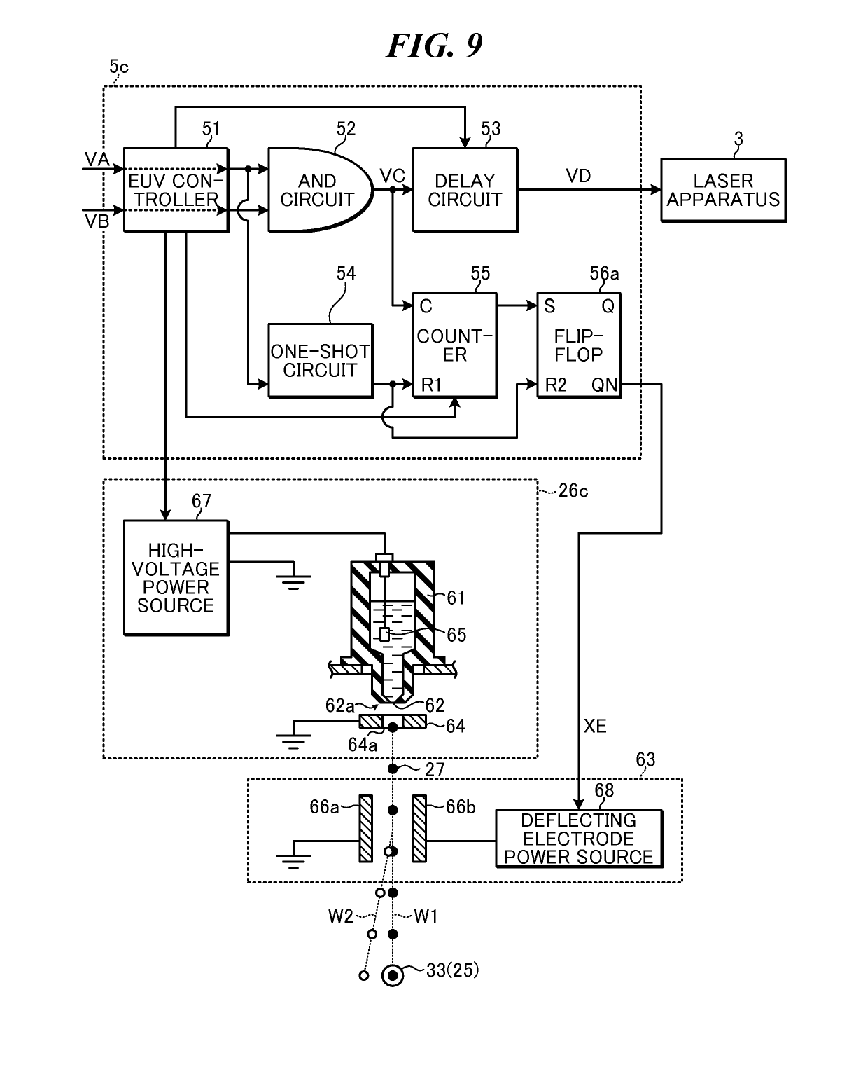

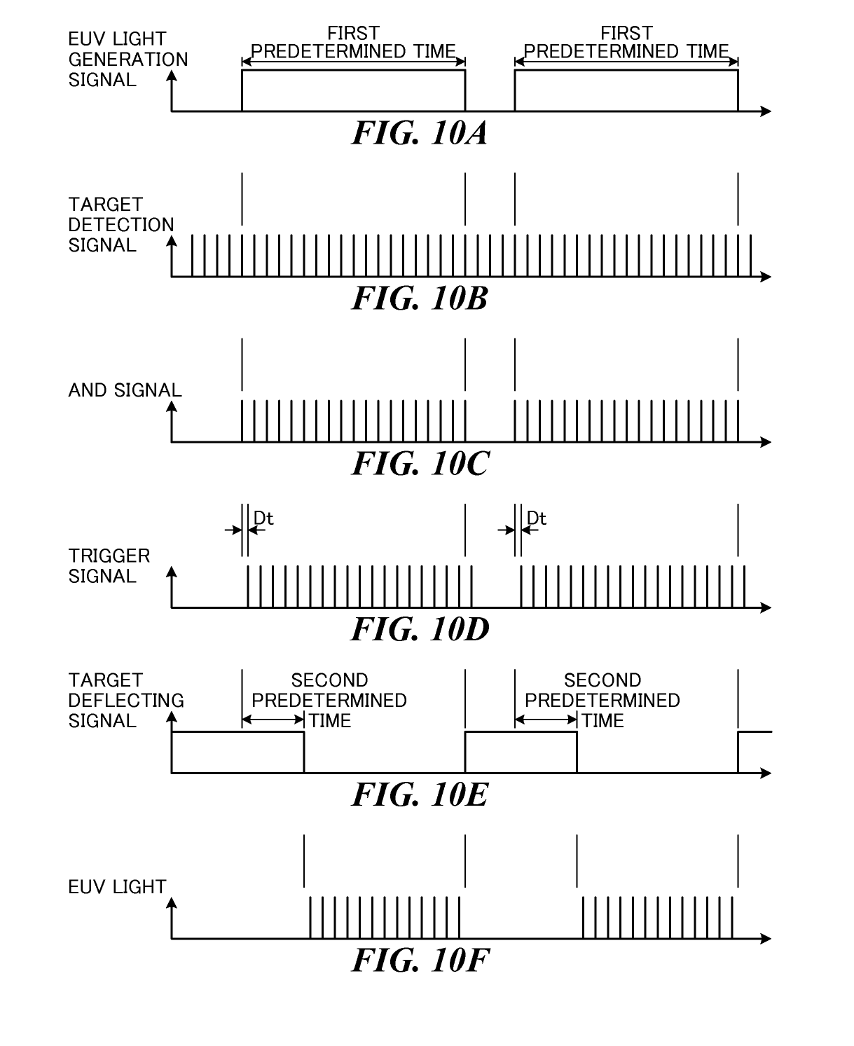

FIG. 9 is a partial cross-sectional view illustrating an EUV light generation controller, a target supply device, and a deflecting device in an EUV light generation system according to a third embodiment. FIGS. 10A to 10F are timing charts illustrating signals from respective constituent elements shown in FIG. 9 and EUV light generated by the EUV light generation system. The signals indicated in FIGS. 10A to 10D can be the same signals as those indicated in FIGS. 5A to 5D, respectively. The output timing of the EUV light indicated in FIG. 10F can be the same as the output timing of the EUV light indicated in FIG. 5F. In this example, the target detection signal VB may serve as a timing signal indicating a supply timing of the targets. In the third embodiment, the EUV light generation system 11 may include a deflecting device 63 disposed in the vicinity of the trajectory of the targets 27.

An EUV light generation controller 5c may include the EUV controller 51, the AND circuit 52, the delay circuit 53, the one-shot circuit 54, the counter 55, and the flip-flop 56a. The counter 55 may include the signal input terminal C and the reset input terminal R1. The flip-flop 56a may include the set input terminal S, the reset input terminal R2, the output terminal Q, and the inverting output terminal QN.

The laser apparatus 3 may not include an optical shutter.

A target supply device 26c may include an extraction electrode 64, a reservoir internal electrode 65, and a high-voltage power source 67. A leading end portion 62a that protrudes in the direction in which the targets are outputted may be formed in the reservoir 61 of the target supply device 26c. The opening 62 of the reservoir 61 may be formed in the leading end portion 62a. The extraction electrode 64 may configure a charging unit that imparts a charge on the targets.

The extraction electrode 64 may be disposed facing the leading end portion 62a of the reservoir 61. A through-hole 64a may be formed in the extraction electrode 64. The extraction electrode 64 may be connected to a constant potential (for example, a ground potential).

The reservoir internal electrode 65 may be electrically connected to the target material held within the reservoir 61 by making contact with the target material held within the reservoir 61. The reservoir internal electrode 65 may further be electrically connected to an output terminal of the high-voltage power source 67.

The EUV controller 51 included in the EUV light generation controller 5c may be configured to output a target control signal to the high-voltage power source 67. The high-voltage power source 67 may apply a high potential to the target material via the reservoir internal electrode 65 based on the target control signal outputted from the EUV controller 51. Through this, a potential difference can be produced between the reservoir internal electrode 65 and the extraction electrode 64.

An electrical field can be produced between the target material in the reservoir 61 and the extraction electrode 64 as a result of the potential difference between the reservoir internal electrode 65 and the extraction electrode 64. A Coulomb force can then be produced between the target material and the extraction electrode 64.

The electrical field concentrates particularly in the periphery of the target material located near the opening 62 formed in the leading end portion 62a, and thus a stronger Coulomb force can be produced between the target material located near the opening 62 and the extraction electrode 64. Due to this Coulomb force, the targets 27 can be outputted from the opening 62 toward the plasma generation region 25 as charged droplets.

The deflecting device 63 may include a pair of deflecting electrodes 66a and 66b and a deflecting electrode power source 68. The pair of deflecting electrodes 66a and 66b may be disposed facing each other, with the trajectory of the targets 27 outputted from the opening 62 toward the plasma generation region 25 positioned therebetween. The one deflecting electrode 66a may be electrically connected to a constant potential (for example, a ground potential), and the other deflecting electrode 66b may be electrically connected to an output terminal of the deflecting electrode power source 68.

The deflecting electrode power source 68 may switch between applying a first potential and applying a second potential to the deflecting electrode 66b based on a target deflecting signal XE (mentioned later).

The first potential may be the same potential as the potential connected to the deflecting electrode 66a (for example, a ground potential). In the case where the first potential is applied to the deflecting electrode 66b, the target 27 may travel in a substantially straight line between the pair of deflecting electrodes 66a and 66b. In the case where the first potential is applied to the deflecting electrode 66b, the target 27 may follow a first trajectory W1 toward the plasma generation region 25 after passing between the pair of deflecting electrodes 66a and 66b.

The second potential may be a different potential from the potential connected to the deflecting electrode 66a (for example, a ground potential). In the case where the second potential is applied to the deflecting electrode 66b, an electrical field can be produced between the pair of deflecting electrodes 66a and 66b. A Coulomb force in a direction along the electrical field can act on the target 27 that is outputted from the opening 62 in a charged state when that target 27 passes between the pair of deflecting electrodes 66a and 66b. The travel direction of the target 27 may be changed by this Coulomb force. The target 27 whose travel direction has been changed may follow a second trajectory W2 that passes outside the plasma generation region 25 after passing between the pair of deflecting electrodes 66a and 66b.

The inverting output terminal QN of the flip-flop 56a included in the EUV light generation controller 5c may output the target deflecting signal XE (see FIG. 10E) to the deflecting electrode power source 68. The target deflecting signal XE can be a high potential (ON) or a low potential (OFF). The target deflecting signal XE may be OFF during a period from when the set input terminal S has received the output pulse signal to when the reset input terminal R2 receives the pulse signal. The target deflecting signal. XE may be ON during a period from when the reset input terminal R2 has received the pulse signal to when the set input terminal S receives the output pulse signal.

In the case where the target deflecting signal XE is ON, the deflecting electrode power source 68 may apply the second potential to the deflecting electrode 66b. Through this, the target 27 can follow the second trajectory W2. In the case where the target deflecting signal XE is OFF, the deflecting electrode power source 68 may apply the first potential to the deflecting electrode 66b. Through this, the target 27 can follow the first trajectory W1.

The configuration may be the same as that described in the first embodiment in other respects.

According to the third embodiment, bursts can be generated throughout the first predetermined time by outputting the trigger signal VD to the master oscillator 35. However, at the beginning of the respective bursts (that is, throughout the second predetermined time), the trajectory of the target 27 can be set to the second trajectory W2 that passes outside the plasma generation region 25. Accordingly, the targets 27 can be suppressed from being irradiated with a pulse laser beam whose energy level is unstable, and electrically neutral debris can be suppressed from being produced.

When the second predetermined time, which is shorter than the first predetermined time, elapses, the first potential can be applied to the deflecting electrode 66b, and the trajectory of the target 27 can be set to the first trajectory W1 that passes through the plasma generation region 25. Through this, the targets 27 can be irradiated with a pulse laser beam whose energy level is stable, and EUV light whose energy level is stable can be generated as a result.

7. EUV Light Generation System that Changes Optical Path of Pre-Pulse Laser Beam

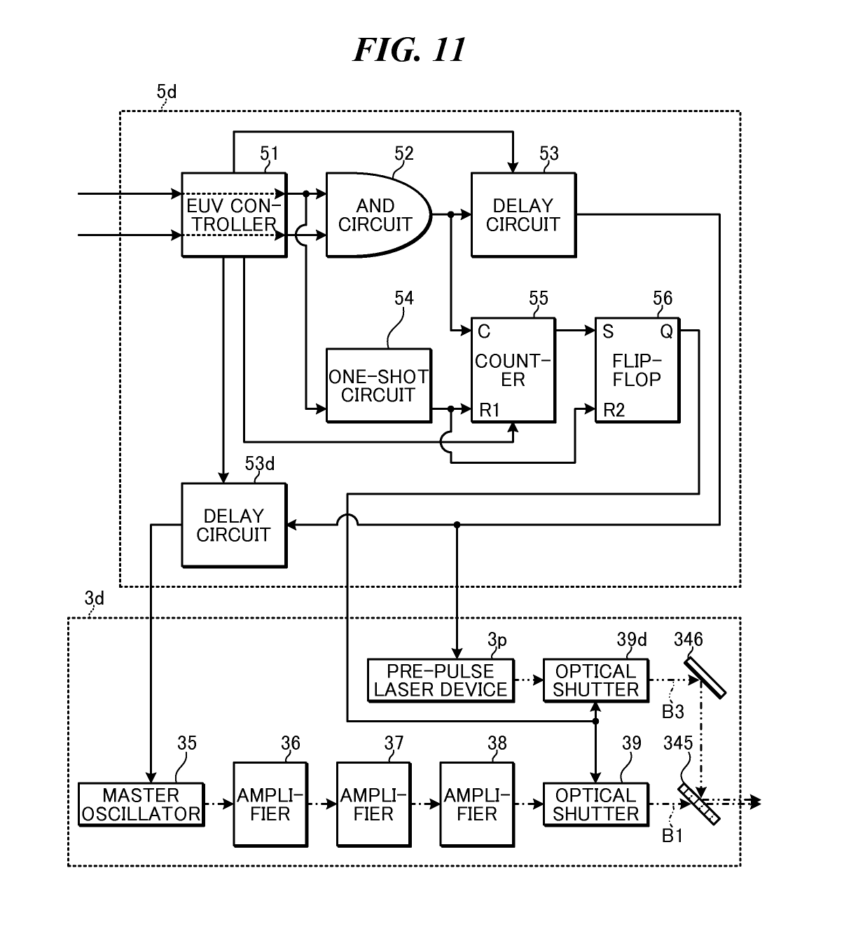

FIG. 11 is a block diagram illustrating an EUV light generation controller and a laser apparatus in an EUV light generation system according to a fourth embodiment. The EUV light generation system according to the fourth embodiment may differ from that of the first embodiment in that a laser apparatus 3d may further include a pre-pulse laser device 3p and an EUV light generation controller 5d may further include a delay circuit 53d.

The laser apparatus 3d may include the master oscillator 35, the amplifiers 36, 37, and 38, and the optical shutter 39. A pulse laser beam outputted by the master oscillator 35 and amplified by the amplifiers 36, 37, and 38 may be referred to in the present embodiment as a main pulse laser beam. The optical shutter 39 may switch an optical path of the main pulse laser beam between the first optical path B1 and a second optical path, in the same manner as described in the first embodiment. The second optical path is not shown in FIG. 11. A dichroic mirror 345 may be disposed in the first optical path B1 of the main pulse laser beam. The main pulse laser beam may be incident on a left side of the dichroic mirror 345, as shown in FIG. 11. The dichroic mirror 345 may allow the main pulse laser beam to pass through at a high level of transmissibility to the right side in FIG. 11.

The pre-pulse laser device 3p may output a pre-pulse laser beam. The pre-pulse laser beam may contain a different wavelength component from a wavelength component contained in the main pulse laser beam. An optical shutter 39d may be disposed in an optical path of the pre-pulse laser beam. Like the optical shutter 39, the optical shutter 39d may switch the optical path of the pre-pulse laser beam between a first optical path B3 and a second optical path based on the output of the flip-flop 56. The second optical path is not shown in FIG. 11. A high-reflecting mirror 346 may be disposed in the first optical path B3 of the pre-pulse laser beam. The high-reflecting mirror 346 may reflect the pre-pulse laser beam at a high level of reflectance.

The pre-pulse laser beam reflected by the high-reflecting mirror 346 may be incident on an upper side of the dichroic mirror 345, as shown in FIG. 11. The dichroic mirror 345 may reflect the pre-pulse laser beam at a high level of reflectance to the right side in FIG. 11. The main pulse laser beam and the pre-pulse laser beam can both be conducted to the plasma generation region 25 as a result.

The delay circuit 53 may output a trigger signal to the pre-pulse laser device 3p and the delay circuit 53d. The delay circuit 53d may generate a main pulse trigger signal by further applying a predetermined delay time to the trigger signal, and may output the main pulse trigger signal to the master oscillator 35. As a result, the main pulse laser beam may be outputted at a timing further delayed from the timing at which the pre-pulse laser beam is outputted.

The EUV controller 51 may output a control signal containing setting information for the predetermined delay time to the delay circuit 53d. The delay time set in the delay circuit 53d may be equivalent to an amount of time required for the target 27 that has been irradiated with the pre-pulse laser beam to diffuse and become a predetermined diffused target.

The flip-flop 56 can output an optical shutter open signal to the optical shutter 39d as well as the optical shutter 39.

The configuration may be the same as that described in the first embodiment in other respects.

According to the fourth embodiment, bursts can be generated throughout the first predetermined time by outputting, to the pre-pulse laser device 3p and the master oscillator 35, trigger signals to which the respective delay times have been applied. However, at the beginning of the respective bursts, the pre-pulse laser beam and the main pulse laser beam can be conducted to the outside of the plasma generation region 25. Through this, the pre-pulse laser beam that has an unstable energy level can be suppressed from striking the target 27, and the main pulse laser beam that has an unstable energy level can be suppressed from striking the diffused target. Accordingly, electrically neutral debris can be prevented from being produced.

When the second predetermined time, which is shorter than the first predetermined time, has elapsed, the optical shutter open signal changes to ON, and the pre-pulse laser beam and the main pulse laser beam can be conducted to the plasma generation region 25. Through this, EUV light that has a stable energy level can be generated by irradiating the target 27 and the diffused target with the pre-pulse laser beam and the main pulse laser beam that have stable energy levels, respectively.

8. EUV Light Generation System that Changes Output Timing of Pre-Pulse Laser Beam

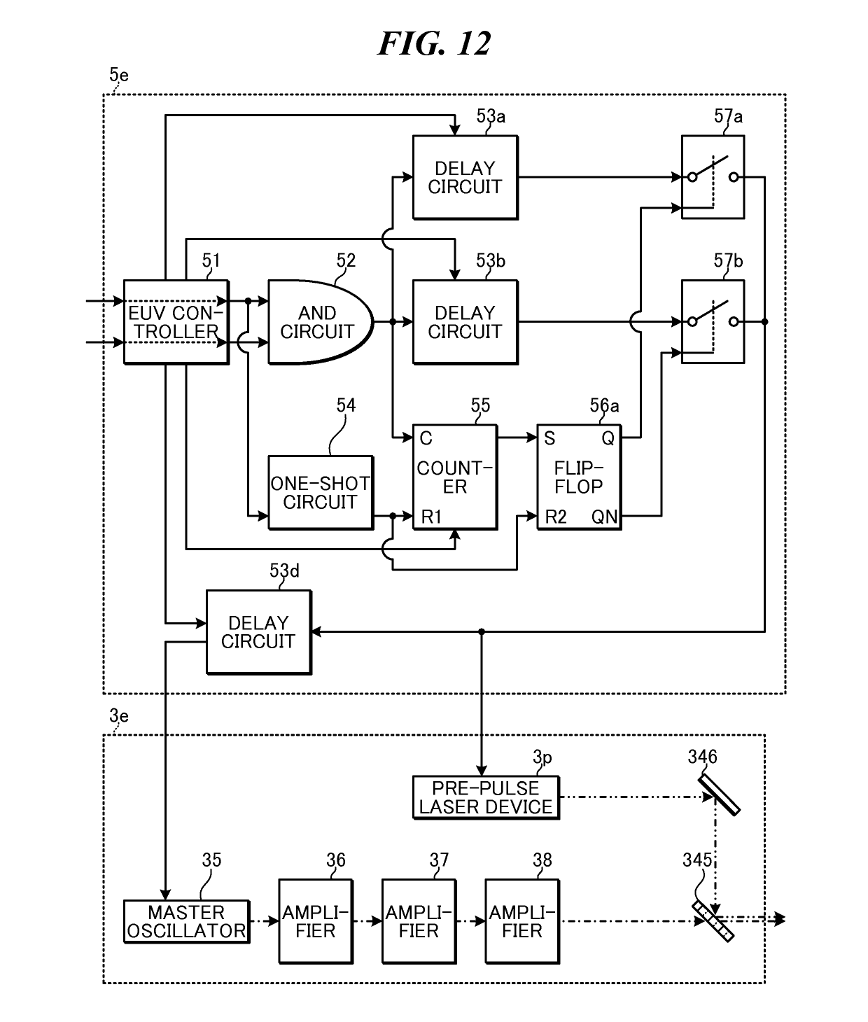

FIG. 12 is a block diagram illustrating an EUV light generation controller and a laser apparatus in an EUV light generation system according to a fifth embodiment. The EUV light generation system according to the fifth embodiment may differ from that of the second embodiment in that a laser apparatus 3e may further include the pre-pulse laser device 3p and an EUV light generation controller 5e may further include the delay circuit 53d.

The laser apparatus 3e may include the master oscillator 35 and the amplifiers 36, 37, and 38. A pulse laser beam outputted by the master oscillator 35 and amplified by the amplifiers 36, 37, and 38 may be referred to in the present embodiment as a main pulse laser beam. An optical shutter may not be disposed in an optical path of the main pulse laser beam. The dichroic mirror 345 may be disposed in the optical path of the main pulse laser beam. The main pulse laser beam may be incident on a left side of the dichroic mirror 345 and may pass through to the right side in FIG. 12.

The pre-pulse laser device 3p may output a pre-pulse laser beam. The pre-pulse laser beam may contain a different wavelength component from a wavelength component contained in the main pulse laser beam. The high-reflecting mirror 346 may be disposed in an optical path of the pre-pulse laser beam. The high-reflecting mirror 346 may reflect the pre-pulse laser beam at a high level of reflectance. The pre-pulse laser beam reflected by the high-reflecting mirror 346 may be incident on an upper side of the dichroic mirror 345, as shown in FIG. 12. The dichroic mirror 345 may reflect the pre-pulse laser beam at a high level of reflectance to the right side in FIG. 12. The main pulse laser beam and the pre-pulse laser beam can both be conducted to the plasma generation region 25 as a result.

The first or second analog switch 57a or 57b may output a first or second delay signal to the pre-pulse laser device 3p and the delay circuit 53d as a trigger signal. The delay circuit 53d may generate a main pulse trigger signal by further applying a predetermined delay time to the trigger signal, and may output the main pulse trigger signal to the master oscillator 35. As a result, the main pulse laser beam may be outputted at a timing further delayed from the timing at which the pre-pulse laser beam is outputted.

The EUV controller 51 may output a control signal containing setting information for the predetermined delay time to the delay circuit 53d. The delay time set in the delay circuit 53d may be equivalent to an amount of time required for the target 27 that has been irradiated with the pre-pulse laser beam to diffuse and become a predetermined diffused target.

The configuration may be the same as that described in the second embodiment in other respects.

According to the fifth embodiment, bursts can be generated throughout the first predetermined time by outputting, to the pre-pulse laser device 3p and the master oscillator 35, trigger signals to which the respective delay times have been applied. However, at the beginning of the respective bursts, the pre-pulse laser beam and the main pulse laser beam can be focused at the plasma generation region 25 at a timing that is shifted from the timing at which the target 27 reaches the plasma generation region 25. Through this, the pre-pulse laser beam that has an unstable energy level can be suppressed from striking the target 27, and the main pulse laser beam that has an unstable energy level can be suppressed from striking the diffused target. Accordingly, electrically neutral debris can be prevented from being produced.

When the second predetermined time, which is shorter than the first predetermined time, elapses, the pre-pulse laser beam can be focused at the plasma generation region 25 at the timing at which the target 27 reaches the plasma generation region 25. Then, the main pulse laser beam can be focused on a desired diffused target at the timing at which that diffused target is generated. Through this, the target 27 and the diffused target can be irradiated respectively with a pre-pulse laser beam and a main pulse laser beam whose energy levels are stable, and EUV light whose energy level is stable can be generated as a result.

Note that the laser apparatus 3 in the third embodiment (see FIG. 9) may further include a pre-pulse laser device. In this case, a configuration for deflecting the trajectory of the target at the beginning of the respective bursts may be the same as that in the third embodiment.

9. EUV Light Generation System that Supplies Targets on Demand

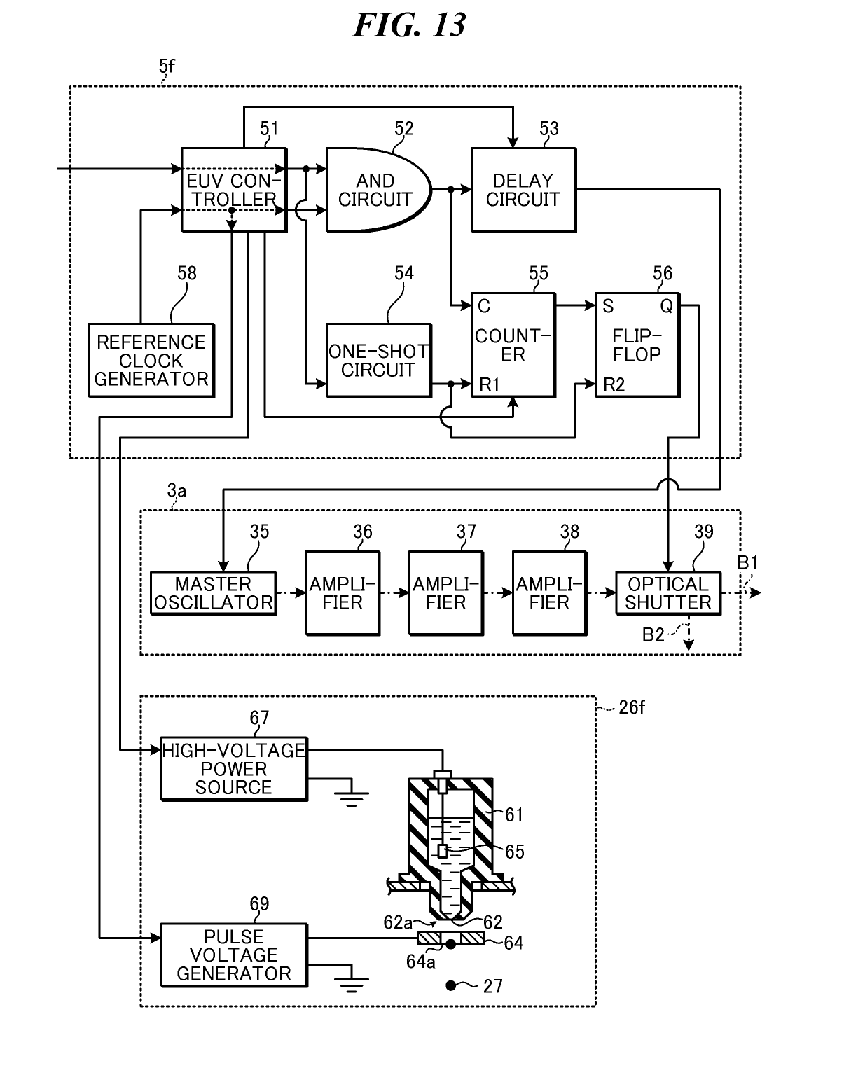

FIG. 13 is a partial cross-sectional view illustrating an EUV light generation controller, a laser apparatus, and a target supply device in an EUV light generation system according to a sixth embodiment. The EUV light generation system according to the sixth embodiment may not include a target sensor. In the sixth embodiment, an EUV light generation controller 5f may include a reference clock generator 58.

The reference clock generator 58 may generate a reference clock signal containing a plurality of pulses based on a predetermined repetition rate and output that reference clock signal to the EUV controller 51. Here, the value of the predetermined repetition rate may be a value that is based on a value set for the repetition rate of the EUV light assigned by the exposure apparatus 6 (see FIG. 1).

The EUV controller 51 may output the reference clock signal received from the reference clock generator 58 to both the AND circuit 52 and a pulse voltage generator 69 (mentioned later).

A target supply device 26f may include the extraction electrode 64, the reservoir internal electrode 65, the high-voltage power source 67, and the pulse voltage generator 69. The leading end portion 62a that protrudes in the direction in which the targets are outputted may be formed in the reservoir 61 of the target supply device 26f. The opening 62 of the reservoir 61 may be formed in the leading end portion 62a.

The extraction electrode 64 may be disposed facing the leading end portion 62a of the reservoir 61. The through-hole 64a may be formed in the extraction electrode 64. The extraction electrode 64 may be electrically connected to an output terminal of the pulse voltage generator 69.

The pulse voltage generator 69 may apply, to the extraction electrode 64, a potential that changes in pulses in accordance with the reference clock signal received from the reference clock generator 58 via the EUV controller 51. This potential may be a potential that changes between, for example, a potential V₁ obtained at times corresponding to each pulse contained in the reference clock signal and a potential V₂ obtained at times between a given pulse and a subsequent pulse.

The reservoir internal electrode 65 may be electrically connected to the target material held within the reservoir 61 by making contact with the target material held within the reservoir 61. The reservoir internal electrode 65 may further be electrically connected to the output terminal of the high-voltage power source 67.

The EUV controller 51 may be configured to output a target control signal to the high-voltage power source 67. The high-voltage power source 67 may apply a high potential V_{H} to the target material via the reservoir internal electrode 65 in accordance with the target control signal received from the EUV controller 51.

The potentials V₁, V₂, and V_{H} may be in a relationship where V₁<V₂≦V_{H}. Through this, a potential difference can be produced between the reservoir internal electrode 65 and the extraction electrode 64. This potential difference can be a larger potential difference at the instant where the potential V₁ is applied to the extraction electrode 64 than when the potential V₂ is applied.

An electrical field is produced between the target material in the reservoir 61 and the extraction electrode 64 as a result of the potential difference between the reservoir internal electrode 65 and the extraction electrode 64, and a Coulomb force can be produced between the target material and the extraction electrode 64 as a result.

The electrical field concentrates particularly in the periphery of the target material located near the opening 62 formed in the leading end portion 62a, and thus a stronger Coulomb force can be produced between the target material located near the opening 62 and the extraction electrode 64. Due to this Coulomb force, the target 27 can be released from the opening 62 toward the plasma generation region 25 in synchronization with the reference clock signal. In this manner, the timing at which the target is supplied may be set based on the reference clock signal. In this example, the reference clock signal may serve as a timing signal that indicates the timing at which the target is supplied.

The AND circuit 52 may use the reference clock signal instead of the target detection signal described in the first embodiment. In other words, the AND circuit 52 may generate an AND signal of the EUV light generation signal and the reference clock signal.

The configuration may be the same as that described in the first embodiment in other respects.

The target supply method employed in the case where the timing at which the targets are supplied is set based on the reference clock signal is not limited to a method that employs the extraction electrode 64 and the pulse voltage generator 69. For example, a method that supplies targets by applying a voltage signal based on the reference clock signal to a piezoelectric element (not shown) and causes a flow channel of the target material to deform or vibrate may be employed as well.

Note that in the aforementioned second embodiment, the timing at which the targets are supplied may be set based on the reference clock signal. In this case, the position of the target when the reference clock is generated may be used instead of the target detection position 40 found by the target sensor when setting the delay time as described with reference to FIG. 7. Assuming that the target is outputted from the opening 62 at the same time as the reference clock is generated, the position of the target when the reference clock is generated may correspond to the position of the opening 62.

Note that in the aforementioned third to fifth embodiments, the timing at which the targets are supplied may be set based on the reference clock signal.

### 10. EUV Light Generation System Including Timer

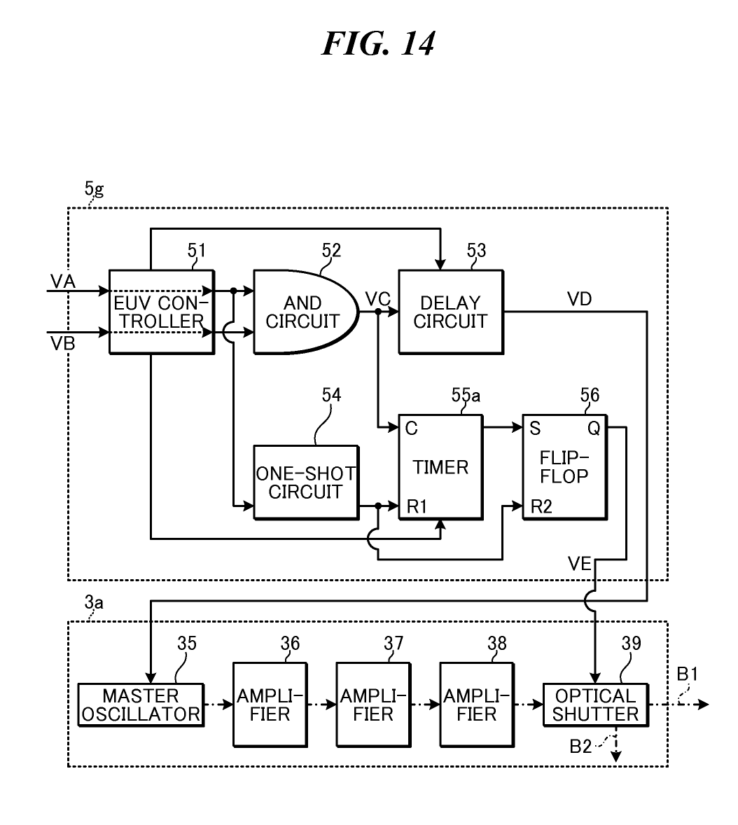

FIG. 14 is a block diagram illustrating an EUV light generation controller and a laser apparatus in an EUV light generation system according to a seventh embodiment. The EUV light generation system according to the seventh embodiment may differ from that of the first embodiment in that an EUV light generation controller 5g may include a timer 55a instead of the counter 55 (see FIG. 3).

The timer 55a may measure time from when the output of the AND signal VC is started. The timing at which the output of the AND signal VC is started can be the timing at which the EUV light generation signal VA turns ON. The timer 55a may measure the second predetermined time from when the output of the AND signal VC is started, and when the second predetermined time has elapsed, the measurement of time may be stopped and the output pulse signal may be generated. The timer 55a may output this output pulse signal to the set input terminal S of the flip-flop 56.

The reset input terminal R1 of the timer 55a may receive, from the one-shot circuit 54, the pulse signal indicating the timing at which the trailing edge of the EUV light generation signal VA has been detected. In the case where the pulse signal has been received by the reset input terminal R1, the timer 55a may reset the time that has already been measured and measure the second predetermined time from when the output of the AND signal VC has started anew.

The configuration may be the same as that described in the first embodiment in other respects.

The above-described embodiments and the modifications thereof are merely examples for implementing the present disclosure, and the present disclosure is not limited thereto. Making various modifications according to the specifications or the like is within the scope of the present disclosure, and other various embodiments are possible within the scope of the present disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. An extreme ultraviolet light generation system comprising:
a laser device configured to output a pulse laser beam;
a chamber in which is provided at least one opening for introducing the pulse laser beam;
a target supply device configured to supply a plurality of targets consecutively to a plasma generation region within the chamber;
a focusing optical system configured to focus the pulse laser beam;
an optical device configured to cause an optical path of the pulse laser beam to approximately match one of a first optical path in which the pulse laser beam is focused at the plasma generation region and a second optical path in which the pulse laser beam passes outside the plasma generation region; and
a control unit configured to output, to the laser device, a trigger signal obtained by applying a predetermined delay time to a timing signal indicating a timing at which the target is to be supplied by the target supply device so that the laser device outputs the pulse laser beam throughout a predetermined time, to count the number of pulses contained in the timing signal, and to output a control signal to the optical device so that the optical device sets the optical path of the pulse laser beam to the second optical path from when the predetermined time starts to when the number of pulses reaches a predetermined value and sets the optical path of the pulse laser beam to the first optical path from when the number of pulses reaches the predetermined value to when the predetermined time ends.

2. An extreme ultraviolet light generation system comprising:
a laser device configured to output a pulse laser beam;
a chamber in which is provided at least one opening for introducing the pulse laser beam;
a target supply device configured to supply a plurality of targets consecutively to a plasma generation region within the chamber;
a focusing optical system configured to focus the pulse laser beam at the plasma generation region; and
a control unit configured to output, to the laser device, a trigger signal obtained by applying one of a first delay time and a second delay time to a timing signal indicating a timing at which the target is to be supplied by the target supply device so that the laser device outputs the pulse laser beam throughout a predetermined time, and to count the number of pulses contained in the timing signal, the control unit being configured to output the trigger signal having applied the first delay time to the timing signal so that the pulse laser beam is focused at the plasma generation region at a timing shifted from an arrival timing at which the target arrives at the plasma generation region from when the predetermined time starts to when the number of pulses reaches a predetermined value, and to output the trigger signal having applied the second delay time to the timing signal so that the pulse laser beam is focused at the plasma generation region at the arrival timing at which the target arrives at the plasma generation region from when the number of pulses reaches the predetermined value to when the predetermined time ends.

3. An extreme ultraviolet light generation system comprising:
a laser device configured to output a pulse laser beam;
a chamber in which is provided at least one opening for introducing the pulse laser beam;
a target supply device configured to supply a plurality of targets consecutively to the interior of the chamber;
a focusing optical system configured to focus the pulse laser beam at a plasma generation region;
a deflecting device configured to cause a trajectory of the target supplied by the target supply device to approximately match one of a first trajectory in which the target passes through the plasma generation region and a second trajectory in which the target passes outside the plasma generation region; and
a control unit configured to output, to the laser device, a trigger signal obtained by applying a predetermined delay time to a timing signal indicating a timing at which the target is to be supplied by the target supply device so that the laser device outputs the pulse laser beam throughout a predetermined time, to count the number of pulses contained in the timing signal, and to output a control signal to the deflecting device so that the deflecting device sets the trajectory of the target to the second trajectory from when the predetermined time starts to when the number of pulses reaches a predetermined value and sets the trajectory of the target to the first trajectory from when the number of pulses reaches the predetermined value to when the predetermined time ends.

4. An extreme ultraviolet light generation system comprising:
a laser device configured to output a pulse laser beam;
a chamber in which is provided at least one opening for introducing the pulse laser beam;
a target supply device configured to supply a plurality of targets consecutively to a plasma generation region within the chamber;
a focusing optical system configured to focus the pulse laser beam;
an optical device configured to cause an optical path of the pulse laser beam to approximately match one of a first optical path in which the pulse laser beam is focused at the plasma generation region and a second optical path in which the pulse laser beam passes outside the plasma generation region; and
a control unit configured to output, to the laser device, a trigger signal obtained by applying a predetermined delay time to a timing signal indicating a timing at which the target is to be supplied by the target supply device so that the laser device outputs the pulse laser beam throughout a first predetermined time, to measure a second predetermined time that is shorter than the first predetermined time, and to output a control signal to the optical device so that the optical device sets the optical path of the pulse laser beam to the second optical path from when the first predetermined time starts to when the second predetermined time ends and sets the optical path of the pulse laser beam to the first optical path from when the second predetermined time ends to when the first predetermined time ends.

5. An extreme ultraviolet light generation system comprising:
a laser device configured to output a pulse laser beam;
a chamber in which is provided at least one opening for introducing the pulse laser beam;
a target supply device configured to supply a plurality of targets consecutively to a plasma generation region within the chamber;
a focusing optical system configured to focus the pulse laser beam at the plasma generation region; and
a control unit configured to output, to the laser device, a trigger signal obtained by applying one of a first delay time and a second delay time to a timing signal indicating a timing at which the target is to be supplied by the target supply device so that the laser device outputs the pulse laser beam throughout a first predetermined time, and to measure a second predetermined time that is shorter than the first predetermined time, the control unit being configured to output the trigger signal having applied the first delay time to the timing signal so that the pulse laser beam is focused at the plasma generation region at a timing shifted from an arrival timing at which the target arrives at the plasma generation region from when the first predetermined time starts to when the second predetermined time ends, and to output the trigger signal having applied the second delay time to the timing signal so that the pulse laser beam is focused at the plasma generation region at the arrival timing at which the target arrives at the plasma generation region from when the second predetermined time ends to when the first predetermined time ends.

6. An extreme ultraviolet light generation system comprising:
a laser device configured to output a pulse laser beam;
a chamber in which is provided at least one opening for introducing the pulse laser beam;
a target supply device configured to supply a plurality of targets consecutively to the interior of the chamber;
a focusing optical system configured to focus the pulse laser beam at a plasma generation region;
a deflecting device configured to cause a trajectory of the target supplied by the target supply device to approximately match one of a first trajectory in which the target passes through the plasma generation region and a second trajectory in which the target passes outside the plasma generation region; and
a control unit configured to output, to the laser device, a trigger signal obtained by applying a predetermined delay time to a timing signal indicating a timing at which the target is to be supplied by the target supply device so that the laser device outputs the pulse laser beam throughout a first predetermined time, to measure a second predetermined time that is shorter than the first predetermined time, and to output a control signal to the deflecting device so that the deflecting device sets the trajectory of the target to the second trajectory from when the first predetermined time starts to when the second predetermined time ends and sets the trajectory of the target to the first trajectory from when the second predetermined time ends to when the first predetermined time ends.

7. The extreme ultraviolet light generation system according to claim 3,
wherein the target supply device includes a charging unit that imparts a charge on the target, and
the deflecting device includes a pair of electrodes disposed between the target supply device and the plasma generation region and a power source configured to apply a voltage between the pair of electrodes, and the deflecting device is configured to generate, based on the control signal, an electrical field in a direction orthogonal to a travel direction of the target supplied by the target supply device.

8. The extreme ultraviolet light generation system according to claim 1, further comprising a target sensor configured to detect the target supplied by the target supply device and output the timing signal.

9. The extreme ultraviolet light generation system according to claim 1, further comprising:
a clock circuit configured to output the timing signal,
wherein the target supply device is configured to supply the target to the plasma generation region within the chamber in accordance with the timing signal.
